(19) United States
(12) Patent Application Publication
(10) Pub. No.: US 2020/0232216 A1
(43) Pub. Date: Jul. 23, 2020

(54) SLAB FRAME DIFFUSING OUTER PERIPHERAL LIGHT AND SLAB COMPRISING SUCH A FRAME

(71) Applicant: NORMALU, kembs (FR)

(72) Inventors: Jean-Marc Scherrer, Riedisheim (FR); Philippe Constanzer, Wittenheim (FR)

(21) Appl. No.: 15/758,834

(22) PCT Filed: Sep. 12, 2016
(86) PCT No.: PCT/FR2016/052288

§ 371 Date: Mar. 9, 2018

(30) Foreign Application Priority Data
Sep. 10, 2015 (FR) 1558392

(51) Int. Cl. E04B 9/32; F21V 33/00; E04F 13/00; E04B 9/30

(52) U.S. Cl. CPC E04B 9/32; F21V 33/006; F21Y 2115/10; E04B 9/303; E04F 13/005

(57) ABSTRACT

A slab frame formed from abutting profile sections each comprising means for attaching at least one tensioned fabric, each profile section comprising two walls connected together by a web, wherein the web comprises two grooves each delimited by the two walls and the web, one of the grooves having an opening at an external periphery of a frame and the other groove emerging at an internal periphery of the frame, each wall being provided, at their respective end delimiting the opening of the groove, with a means for attaching a tensioned fabric, and in that at least one of the profile sections comprises light-emitting means fixed to the inside of the associated groove having an opening at the external periphery of the frame.

### BACKGROUND OF THE INVENTION

The invention relates to the field of slabs for producing suspended ceilings, false walls or suspended decorative elements.

The invention relates more particularly to a frame for producing a slab that is wholly or partly light-emitting.

Slabs for producing suspended ceilings or false walls conventionally comprise a rigid frame, generally metal, provided with or without a base, and at least one fabric, generally made from PVC, tensioned over the frame.

Depending on whether or not the slabs are provided with a base, the lighting is integrated in different ways.

Thus, when the slabs are formed by a frame provided with a base, the lighting thereof is obtained by placing light-emitting means, of the LED type, on the base wall. By way of example, the patent application FR 2998315 may be cited, describing such a type of slab.

When the slabs have no base, or when the base is replaced by a tensioned fabric, the lighting thereof is obtained by positioning light-emitting means on the part of the ceiling or wall opposite which the slabs are fixed. By way of example, the patent application FR 2970013 may be cited, filed by the applicant and describing a slab comprising a frame on which three tensioned fabrics are fixed and illuminated by light-emitting means fixed to the ceiling.

These slabs of the prior art do however have the drawback of offering lighting limited to the inside of the frame.

### SUMMARY OF THE INVENTION

The invention aims to remedy this problem by proposing a light-emitting frame diffusing outer peripheral light.

Another object of the invention is to propose a light-emitting frame making it possible to modulate the light diffused at the periphery while being simple to maintain and easy to implement.

Another object of the invention is to propose a slab or a combination of slabs comprising such a frame.

To this end, and according to a first aspect, the invention proposes a slab frame formed by abutting profile sections each comprising means for attaching at least one tensioned fabric. The frame is remarkable in that each profile section comprises two walls connected together by a web, said web delimiting with the walls a groove having an opening at the external periphery of the frame, each wall being provided, at the respective end thereof delimiting the opening of the external groove, with a means for attaching a tensioned fabric, and in that at least one of the profile sections comprises light-emitting means fixed to the inside of the associated groove.

The frame thus arranged makes it possible to diffuse outer peripheral light.

Advantageously, the frame comprises means for the uniform diffusion of the light emitted by the light-emitting means, said diffusion means being arranged to close the opening of the groove.

According to a particular configuration, the diffusion means comprise at least one transparent or translucent sheet. Advantageously, the sheet is a sheet made from Plexiglas.

Advantageously, the groove comprises tongues for holding a diffusion sheet placed between the walls so as to close the opening of the groove.

According to another configuration, the diffusion means are formed by a portion of a tensioned fabric fixed to the frame, said fabric being for example made from polyvinyl chloride or textile.

Advantageously, the web is arranged so as to delimit with the walls a groove emerging at the internal periphery of the frame. According to a particular configuration, provision may be made for the groove emerging at the internal periphery of the frame to comprise light-emitting means. Thus, depending on the effect sought, the frame may diffuse light either on its external periphery or on its internal periphery, or on each of its peripheries.

Advantageously, the means for attaching the fabric of each wall comprise a groove comprising a shoulder arranged so as to allow holding of the fabric by means of an attachment means of the forked tie type equipping the border of the fabric or by means of an intermediate profile section on which the fabric is held by gripping.

The invention also relates to a slab comprising a frame as described above.

The invention also relates to a frame profile section for producing a frame as described previously. The frame profile section again comprises, alone or in combination, the features of the profile section of the frame described above.

### BRIEF DESCRIPTION OF THE DRAWINGS

Other objects and advantages of the invention will emerge during the following description, given with reference to the accompanying drawings, in which:

FIG. 1 shows a partial schematic view of a profile section of a slab frame according to a first embodiment of the invention;

FIG. 2 shows a partial schematic view of a frame according to a second embodiment of the invention.

For more clarity, the identical or similar elements of the various embodiments are marked by identical reference signs in all the figures.

### DETAILED DESCRIPTION

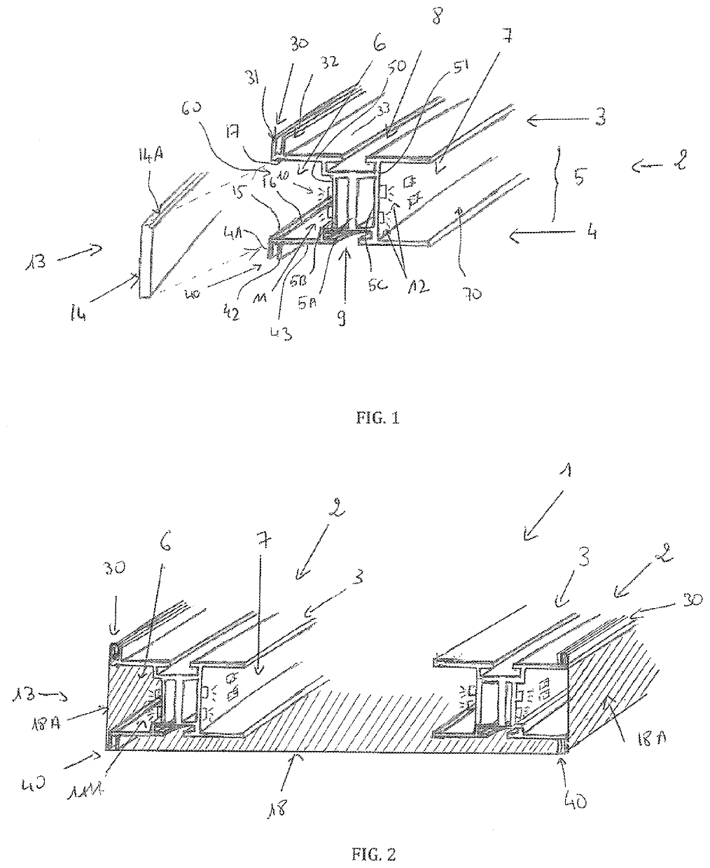

The description of the frames that follows is given with reference to use of a false-ceiling slab frame. Thus the terms “top” and “bottom” are used with reference to this use, that is to say the one illustrated in FIGS. 1 and 2.

In relation to FIG. 1, a frame profile section 2 is described, said frame being formed by assembling such profile sections.

The profile section 2 has a cross section in the form of a turned-over H.

More particularly, the profile section comprises a top wall 3 and a bottom wall 4 disposed parallel to the top wall 3, said walls being connected together by a web 5. It further comprises two grooves 6, 7, one emerging on the lateral edge of the profile section defining, with the other profile sections, the external contour of the frame, the other emerging on the lateral frame of the profile section defining, with the other profile sections, the internal contour of the frame. These grooves are hereinafter designated respectively external groove 6 and internal groove 7. The external and internal grooves 6, 7 are thus delimited by three common walls, namely the top and bottom walls 3, 4 and the web 5. As illustrated in FIG. 1, said grooves 6, 7 are arranged so as to have openings opposite one another.

Each wall 3, 4 comprises, at their end delimiting the opening 60 of the external groove 6, two longitudinal flanges 31, 32, 41, 42 parallel to each other. Said flanges are arranged so as to delimit a groove 30, 40 arranged so as to enable a tensioned fabric to be attached. The tensioned fabric may be attached for example by means of an attachment means of the forked tie type equipping the border of the fabric that is attached to a shoulder provided in each of the grooves 30, 40. The tensioned fabric may also be attached by means of an intermediate profile section on which the fabric is fixed. The intermediate profile section comprises deformable longitudinal projections arranged so as to hold the fabric by gripping. With a shape complementary to that of the groove 30, 40, it is configured so as to fit removably in the groove 30, 40, the aforementioned shoulder constituting a stop for holding the intermediate profile section in the groove 30, 40 in which it is placed.

In the embodiment illustrated, the flanges 31, 32, 41, 42 of each of the walls 3, 4 extend from the face, respectively top and bottom 33, 43, of the associated wall and substantially perpendicular thereto. The flanges 31, 32, 41, 42 of each wall 3, 4 thus define two fabric-reception grooves 30, 40 extending in opposite directions.

Each wall 3, 4 also comprises a channel 8, 9 arranged to define a T-shaped groove. The channel 8 of the top wall 3 is intended to receive a hanger of a suspension structure for attaching the frame to the ceiling.

In the embodiment illustrated, the web 5 is recessed. It comprises a connecting strut 5A and two reinforcing struts 5B, 5C disposed on either side of the connecting strut 5A. The connecting and reinforcing struts 5A, 5B, 5C extend between the channels 8, 9 respectively of the top wall 3 and of the bottom wall 4. According to a particular configuration, the reinforcing strut 5B delimiting the external groove 6 is arranged so as to define, with the channels 8, 9, a channel 10, while the strut 5C delimiting the internal groove 7 extends in the same plane as that of the lateral walls situated on the same side as the internal groove 7. The channel 10 makes it possible to fit angle brackets to connect the frames.

In order to allow peripheral lighting of the frame, the light-emitting means 11, for example LEDs, are placed in the external groove 6 of each profile section 2 constituting the frame. It is of course obvious that, according to the effect sought, the profile sections of the same frame may not all be equipped with light-emitting means.

FIG. 1 shows a configuration in which the light-emitting means 11 are fixed to the bottom of the groove 6, in the channel 10. In this example, the bottom is formed by the reinforcing strut 5B. This is of course an example of positioning, it being understood that the light-emitting means may also be provided on one or both lateral walls of the external groove 6, in addition to or in replacement for those fixed to the bottom of the groove 6. The presence of light-emitting means in the external groove 6 makes it possible to create a halo of light on the external periphery of the frame.

In the embodiment illustrated, the frame also comprises light-emitting means 12 fixed in the internal groove 7, on the bottom of the latter. In this example, the bottom is formed by the reinforcing strut 5C. The presence of light-emitting means in the internal groove 7 makes it possible to create a halo of light on the internal periphery of the frame, thus illuminating the tensioned fabric when it is fixed to the frame. Just as in the groove 6, the light-emitting means 12 may also be fixed to one or both lateral walls of the internal groove 7, in addition to or in replacement for those fixed to the reinforcing strut 5C. It is of course obvious that the presence of light-emitting means in the internal groove 7 of the profile section is optional and that a profile section provided with light-emitting means only in its external groove may be provided.

Advantageously, the profile section 2 comprises means 13 for diffusing the light emitted by the light-emitting means. In the embodiment illustrated in FIG. 1, the light-diffusion means comprise a transparent or translucent sheet 14, preferably made from Plexiglas, interposed between the top and bottom walls 3, 4 so as to close the opening 60 of the external groove 6. In order not to burden FIG. 1, the sheet 14 has been shown in FIG. 1 not mounted on the profile section 2.

The sheet 14 is held by two longitudinal tongues 15, 16 provided on the face of the bottom wall 4 defining the bottom lateral wall of the external groove 6 and by a longitudinal tongue 17 provided on the face of the top wall 3 defining the top lateral wall of the external groove 6, said tongue 17 being arranged so as to be inserted in a groove 14A provided on one of the longitudinal edges of the sheet. This is of course an example of holding the sheet. It is of course obvious that the invention is not limited to this example of fixing the sheet, other fixing techniques holding the sheet in position being able to be implemented without departing from the scope of the invention. As illustrated, the tongues 15, 16, 17 are provided in the vicinity of the ends delimiting the opening 60 of the external groove 6.

Advantageously, the sheet 14 is removable. It is mounted by sliding in the rail defined by the two bottom tongues 15, 16 and along the top tongue 17.

FIG. 2 illustrates a frame 1 according to another embodiment. The frame 1 illustrated partially is formed by profile sections 2 repeating all the features of the profile section illustrated in FIG. 1. In this embodiment, however, the uniform diffusion of light is achieved not by means of a Plexiglas sheet but by means of a fabric 18 tensioned over the frame 1. To do this, and as illustrated in FIG. 2, the fabric 18, preferably made from polyvinyl chloride or textile, is mounted on the underface of the frame 1 and is fixed to the attachment means (grooves 30) of the top walls 3 of each of the profile sections 2. The fabric 18 thus disposed has a vertical part 18A extending in front of the opening of the external groove 6 so as to ensure uniform diffusion of the light emitted by the light-emitting means 11.

In the examples described previously, the light-emitting means are shown fixed individually in the grooves of the profile section. It is of course obvious that the invention is not limited to this configuration and that a configuration may be provided in which the light-emitting means consist of a support plate on which light-emitting means, of the LED type, are fixed, said support plate advantageously covering the whole of the wall of the bottom of the groove.

The invention is described above by way of example. Naturally a person skilled in the art is in a position to implement different variant embodiments of the invention without departing from the scope of the invention.

1. A slab frame formed from abutting profile sections each comprising means for attaching at least one tensioned fabric, each profile section comprising two walls connected together by a web, wherein the web comprises two grooves each delimited by the two walls and the web, one of the grooves having an opening at an external periphery of a frame and the other groove emerging at an internal periphery of the frame, each wall being provided, at their respective end delimiting the opening of the groove, with a means for attaching a tensioned fabric, and in that at least one of the profile sections comprises light-emitting means fixed to the inside of the associated groove having an opening at the external periphery of the frame.

2. The slab frame according to claim 1, wherein the frame comprises means for the uniform diffusion of the light emitted by the light-emitting means, said diffusion means being arranged to close the opening of the groove.

3. The slab frame according to claim 2, wherein the diffusion means comprise at least one transparent or translucent sheet.

4. The slab frame according to claim 3, wherein the sheet is made from Plexiglas.

5. The slab frame according to claim 4, wherein the groove having an opening at the external periphery of the frame comprises tongues for holding a diffusion sheet placed between the walls so as to close the opening of the groove.

6. The slab frame according to claim 2, wherein the diffusion means are formed by a portion of a tensioned fabric fixed to the frame.

7. The slab frame according to claim 6, wherein the fabric is made from at least one of a polyvinyl chloride or a textile.

8. The slab frame according to claim 7, wherein the groove emerging at the internal periphery of the frame comprises light-emitting means.

9. The slab comprising a frame according to claim 8 and a fabric tensioned on said frame.

10. The frame profile section for producing a frame according to claim 8, said profile section comprising light-emitting means fixed to the inside of the associated groove.
